(19) United States
(12) Patent Application Publication
(10) Pub. No.: US 2025/0259586 A1
(43) Pub. Date: Aug. 14, 2025

(54) DISPLAY PANEL AND DISPLAY DEVICE

(71) Applicant: Xiamen Tianma Display Technology Co., Ltd., Xiamen (CN)

(72) Inventor: Rui LI, Xiamen (CN)

(21) Appl. No.: 19/193,899

(22) Filed: Apr. 29, 2025

(30) Foreign Application Priority Data
Dec. 16, 2024 (CN) 202411854235.7

(51) Int. Cl. G09G 3/20

(52) U.S. Cl. CPC G09G 3/2074; G09G 2300/0426; G09G 2320/0209

(57) ABSTRACT

Provided are a display panel and a display device. The display panel includes: a first trace area; a first display area at least half-surrounding the first trace area; a plurality of connection data lines each including a first portion located in the first trace area and a second portion located in the first display area electrically connected to each other; and a plurality of pixel column groups located in the first display area, each pixel column group including at least two pixel columns, and each pixel column being electrically connected to two connection data lines; the plurality of pixel column groups including adjacent first and second pixel column groups, where the first portions of the first connection data lines corresponding to the first pixel column group and the first portions of the second connection data lines corresponding to the second pixel column group are located in different layers.

### CROSS-REFERENCE TO RELATED APPLICATION

The present application claims priority to Chinese Patent Application No. 202411854235.7, filed on Dec. 16, 2024, the content of which is incorporated herein by reference in its entirety.

### TECHNICAL FIELD

The present application relates to the field of display technology, and in particular, to a display panel and a display device.

### BACKGROUND

Currently, in products with a design that combines an AA Hole (display area hole) and DDL (double data line), the data traces around the hole border adopt a winding layout design. Moreover, compared with the single data line design, the number of data traces on the hole border doubles. Under the limitation of the hole border size, signal crosstalk is prone to occur between the data traces on the hole border, thereby affecting the display effect.

### SUMMARY

A main objective of the present application is to provide a display panel and a display device to at least solve the problem of poor display effect of the display panel in the prior art.

To achieve the above-mentioned objective, according to one aspect of the present application, there is provided a display panel including:
a first trace area;
a first display area at least half-surrounding the first trace area;
a plurality of connection data lines, each of which includes a first portion and a second portion electrically connected to each other, the first portion located in the first trace area, and the second portion located in the first display area; and
a plurality of pixel column groups located in the first display area, each of the pixel column groups including at least two pixel columns, and each of the pixel columns being electrically connected to two connection data lines;
the plurality of pixel column groups including adjacent first pixel column group and second pixel column group, and the plurality of connection data lines including first connection data lines corresponding to the first pixel column group and second connection data lines corresponding to the second pixel column group, where the first portions of the first connection data lines and the first portions of the second connection data lines are located in different layers.

According to another aspect of the present application, based on the same inventive concept, there is provided a display device including a display panel, and the display panel includes:
a first trace area;
a first display area at least half-surrounding the first trace area;
a plurality of connection data lines, each of which includes a first portion and a second portion electrically connected to each other, the first portion located in the first trace area, and the second portion located in the first display area; and
a plurality of pixel column groups located in the first display area, each of the pixel column groups including at least two pixel columns, and each of the pixel columns being electrically connected to two connection data lines. The plurality of pixel column groups includes adjacent first pixel column group and second pixel column group, and the plurality of connection data lines includes first connection data lines corresponding to the first pixel column group and second connection data lines corresponding to the second pixel column group. The first portions of the first connection data lines and the first portions of the second connection data lines are located in different layers.

### BRIEF DESCRIPTION OF DRAWINGS

The accompanying drawings, which are part of the present application are used to provide a further understanding of the present application. The schematic embodiments of the present application and their descriptions are used to explain the present application and do not form an improper limitation to the present application. In the accompanying drawings:

FIG. 1 shows a schematic top view of a display panel provided according to an embodiment of the present application;

FIG. 2 shows a schematic cross-sectional view of the first portions corresponding to two adjacent pixel column groups provided according to an embodiment of the present application;

FIG. 3 shows another schematic cross-sectional view of the first portions corresponding to two adjacent pixel column groups provided according to an embodiment of the present application;

FIG. 4 shows a further schematic cross-sectional view of the first portions corresponding to two adjacent pixel column groups provided according to an embodiment of the present application;

FIG. 5 shows a schematic top view of an arrangement of scan lines provided according to an embodiment of the present application;

FIG. 6 shows a schematic top view of another arrangement of scan lines provided according to an embodiment of the present application;

FIG. 7 shows another schematic top view of a display panel provided according to an embodiment of the present application; and

FIG. 8 shows a structural schematic view of a display device provided according to an embodiment of the present application.

Where the above-mentioned accompanying drawings include the following reference numerals:

10, display panel; 11, first trace area; 12, first display area; 13, connection data line; 131, first connection data line; 132, second connection data line; 14, first portion; 141, first target portion; 142, second target portion; 15, second portion; 16, pixel column group; 161, first pixel column group; 162, second pixel column group; 17, pixel column; 18, first metal layer; 19, interlayer insulating layer; 20, second metal layer; 21, hole structure; 22, scan line; 221, first scan sub-line; 222, second scan sub-line; 23, non-display area; 24, multiplexer; 25, display device; 26, second display area.

### DESCRIPTION OF EXAMPLES

It should be noted that, in the case of no conflict, the embodiments in the present application and the features in the embodiments can be combined with each other. The following will describe the present application in detail with reference to the drawings and embodiments.

To enable those skilled in the art to understand the solutions of the present application better, the technical solutions in the embodiments of the present application will be clearly and completely described below in combination with the drawings in the embodiments of the present application. Apparently, the described embodiments are only some embodiments of the present application, not all of them. Based on the embodiments in the present application, all other embodiments obtained by those of ordinary skill in the art without creative efforts shall fall within the protection scope of the present application.

It should be noted that the terms “first”, “second”, etc. in the specification, claims, and drawings of the present application are used to distinguish similar objects, and do not necessarily need to describe a specific sequence or chronological order. It should be understood that the terms used in this way are interchangeable in proper circumstances so that the embodiments of the present application described herein can be implemented in other orders than the order illustrated or described herein. Moreover, the terms “include”, “have” and any other variants thereof mean to cover and be non-exclusive inclusion, for example, a process, method, system, product, or device that includes a series of steps or units is not necessarily limited to those steps or units clearly listed, but may include other steps or units not clearly listed or inherent to the process, methods, product, or device.

As introduced in the background, there is a technical problem of poor display effect of the display panel in the prior art. To solve the above-mentioned technical problem, the embodiments of the present application provide a display panel and a display device.

The technical solutions in the embodiments of the present application will be clearly and completely described below in combination with the drawings in the embodiments of the present application.

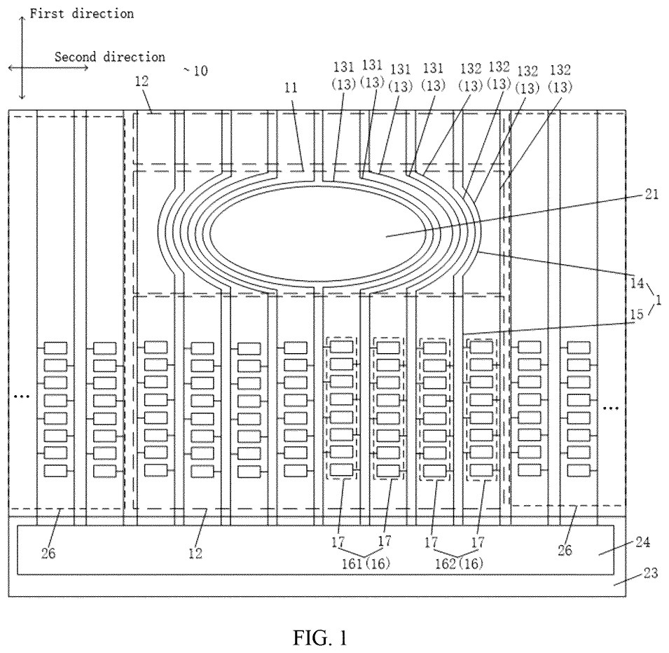

In the present embodiment, a display panel is provided. FIG. 1 is a schematic top view of a display panel provided according to an embodiment of the present application. As shown in FIG. 1, the display panel 10 includes a first trace area 11, a first display area 12, a plurality of connection data lines 13 and a plurality of pixel column groups 16.

A first display area 12 at least half-surrounds the first trace area 11.

Specifically, the first trace area 11 can be partially encircled by the first display area 12 with an opening left, that is, not completely enclosed; and the first trace area 11 can also be enclosed by the first display area, that is, completely enclosed.

Each of the plurality of connection data lines 13 includes a first portion 14 and a second portion 15 electrically connected to each other, the first portion 14 is located in the first trace area 11, and the second portion 15 is located in the first display area 12.

Specifically, one end of the first portion 14 is electrically connected to one end of the second portion 15.

A plurality of pixel column groups 16 are located in the first display area 12, each of the pixel column groups 16 includes at least two pixel columns 17, and each of the pixel columns 17 is electrically connected to two connection data lines 13.

Specifically, each of the pixel columns 17 is electrically connected to two different connection data lines 13, that is, the display panel uses a double data line (abbreviated as ddl) method for signal transmission, and the two connection data lines 13 can be located on both sides of the electrically connected pixel column 17, or on the same side of the electrically connected pixel column 17.

The plurality of pixel column groups 16 include adjacent first pixel column group 161 and second pixel column group 162, the plurality of connection data lines 13 include first connection data lines 131 corresponding to the first pixel column group 161 and second connection data lines 132 corresponding to the second pixel column group 162, where the first portions 14 of the first connection data lines 131 and the first portions 14 of the second connection data lines 132 are located in different layers.

Specifically, the first pixel column group 161 correspond to a plurality of first connection data lines 131, and the second pixel column group 162 correspond to a plurality of second connection data lines 132, the parts of the first connection data lines 131 that are located in the first trace area 11 and the parts of the second connection data lines 132 that are located in the first trace area are located in different layers.

Through the embodiment, in the display panel, the first display area at least half encloses the first trace area, the first display area is provided with the plurality of pixel column groups, each of the pixel column groups includes at least two pixel columns, each of the pixel columns is electrically connected to two connection data lines correspondingly, signal transmission is carried out through the DDL method, the first portion of each of the connection data lines is located in the first trace area, the second portion of each of the connection data lines is located in the first display area, and the first portions of the connection data lines corresponding to adjacent pixel column groups are located in different layers. Due to the smaller wiring space in the first trace area, the connection data lines in the first trace area are prone to signal crosstalk problem. In the present application, the first portions of the connection data lines corresponding to adjacent pixel column groups are disposed in different layers, so that adjacent connection data lines in the same layer correspond to the pixel column groups in alternate columns. When the connection data lines of the pixel column groups in alternate columns are charged, there is no time sequence overlap, avoiding the problem of signal crosstalk between the connection data lines corresponding to adjacent pixel column groups, realizing high-quality and stable signal transmission, and ensuring a better display effect of the display panel. Moreover, compared with disposing the first portions corresponding to adjacent pixel column groups in the same layer, in the present application, the wiring interval of the first portions on each layer does not need to consider the crosstalk problem, so that the spacing between adjacent first portions can be smaller, thereby ensuring that the wiring area occupied by the first portions in the first trace area is smaller.

Each of the pixel columns 17 is composed of a plurality of pixels arranged at intervals along a first direction, and each of the pixel column groups 16 is composed of a plurality of pixel units arranged at intervals in the first direction. One pixel unit includes a plurality of pixels. The first direction is the extension direction of the pixel column, also called the column direction.

In some embodiments, in a thickness direction of the display panel, the first portions 14 of the first connection data lines 131 and the first portions 14 of the second connection data lines 132 overlap each other. Since the first portions of the first connection data lines and the first portions of the second connection data lines are located in different layers, disposing the first portions of the two to overlap in the thickness direction will not cause signal crosstalk problem and can ensure that the wiring area of the plurality of connection data lines in the first trace area is smaller.

Since there are a plurality of the first connection data lines 131 in the first pixel column group and there are a plurality of the second connection data lines 132 in the second pixel column group, the overlapping manner of the first portions 14 of the plurality of the first connection data lines 131 and the first portions 14 of the plurality of the second connection data lines 132 can be any feasible way. For example, the first portions of the first connection data lines 131 and the first portions of the second connection data lines 132 overlap each other in a one-to-one correspondence. Another example is that the first portion of one first connection data line 131 overlaps the first portions of a plurality of the second connection data lines 132.

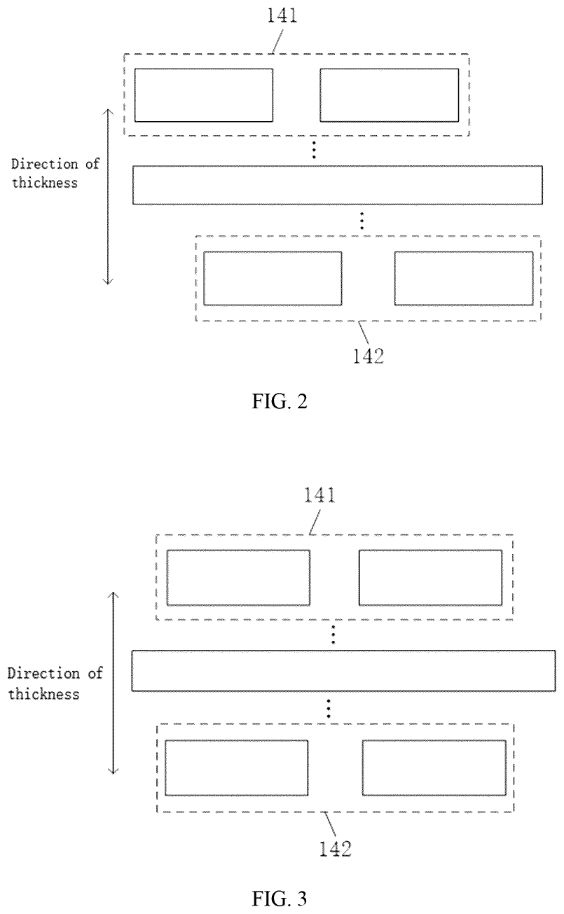

In some exemplary embodiments of the present application, as shown in FIG. 2, one of the pixel columns located at a preset position in the first pixel column group is a first target pixel column, and one of the pixel columns located at a preset position in the second pixel column group is a second target pixel column. The first portions 14 of the two first connection data lines electrically connected to the first target pixel column are first target portions 141, and the first portions 14 of the two second connection data lines electrically connected to the second target pixel column are second target portions 142. In the thickness direction of the display panel, at least one of two first target portions 141 and at least one of two second target portions 142 overlap each other. In this embodiment, in two adjacent pixel column groups, the two connection data lines connected to the pixel columns at the corresponding positions overlap each other in the first trace area. As such, the wiring of the first portions in different layers is made basically the same, which is conducive to simplifying the wiring design and manufacturing process.

In some embodiments, the first target pixel column and the second target pixel column are located at the corresponding positions in adjacent pixel column groups. For example, in the case where the first target pixel column is the first pixel column in the first pixel column group, the second target pixel column is the first pixel column in the second pixel column group. One first target portion can overlap one of the two second target portions, or can overlap both of the two second target portions; the other first target portion can overlap one of the two second target portions, or can overlap both of the two second target portions.

In order to further reduce the wiring area occupied by the connection data lines in the first trace area and at the same time further simplify the design of the connection data lines in the first trace area, in the present application, as shown in FIG. 3, in the thickness direction of the display panel, the first target portions 141 and the second target portions 142 overlap each other in a one-to-one correspondence.

In some embodiments, the relative position relationship between the two first connection data lines and the first target pixel column is the same as the relative position relationship between the two second connection data lines and the second target pixel column. For example, the two first connection data lines are distributed on both sides of the first target pixel column, the two second connection data lines are distributed on both sides of the second target pixel column. The first portion of the first connection data line located on the first side of the first target pixel column overlaps the first portion of the second connection data line located on the first side of the second target pixel column, and the first portion of the first connection data line located on the second side of the first target pixel column overlaps the first portion of the second connection data line located on the second side of the second target pixel column. For another example, the two first connection data lines are distributed on the same side of the first target pixel column, one first connection data line is closer to the first target pixel column than the other first connection data line. The two second connection data lines are distributed on the same side of the second target pixel column, one second connection data line is closer to the second target pixel column than the other second connection data line. The first portion of the first connection data line closer to the first target pixel column overlaps the first portion of the second connection data line closer to the second target pixel column, and the first portion of the first connection data line farther from the first target pixel column overlaps the first portion of the second connection data line farther from the second target pixel column.

In the actual application process, there are a plurality of the first pixel column groups and a plurality of the second pixel column groups in the display panel. Those skilled in the art can dispose a plurality of layers and solve the signal crosstalk problem by allocating the layers where the first portions of the first and second connection data lines are located.

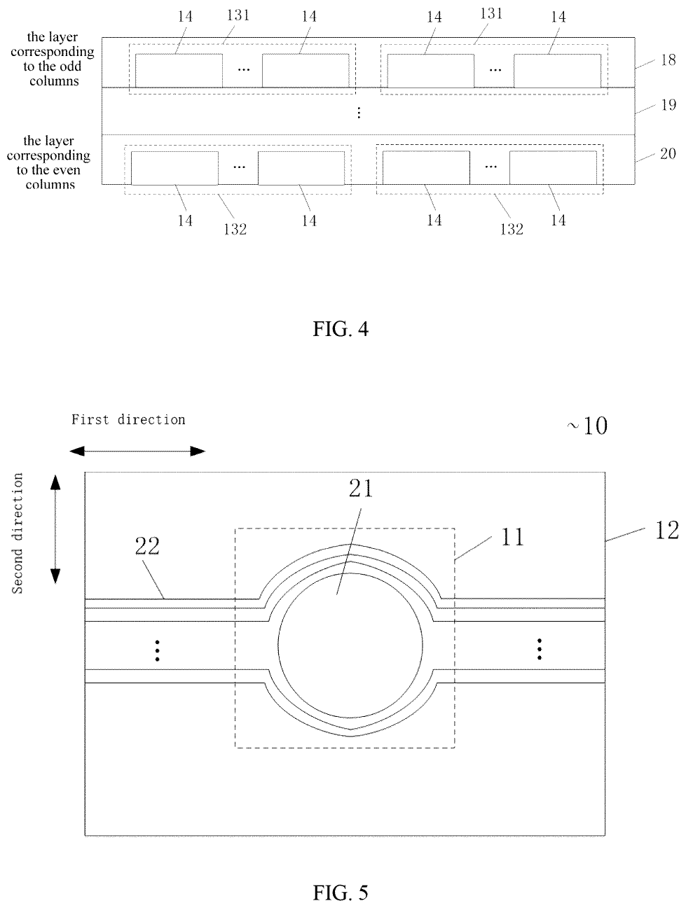

In order to take into account the display effect as well as the lightweight and thinness design requirements of the display panel, in another optional solution, as shown in FIG. 4, there are a plurality of the first pixel column groups and a plurality of the second pixel column groups, the plurality of the first pixel column groups are arranged in odd columns, the plurality of the second pixel column groups are arranged in even columns. That is, the first pixel column group and second pixel column group are arranged alternately. The first portions of all the first connection data lines 131 are located in a same layer, and the first portions of all the second connection data lines 132 are located in another same layer. That is to say, the first portions of all the connection data lines are arranged in two layers. In this way, not only the problem of signal crosstalk between the connection data lines corresponding to adjacent pixel column groups can be further solved, ensuring a good display effect of the display panel, but also the number of layers occupied by the first portions of the connection data lines can be reduced, thereby realizing the lightweight and thinness design of the display panel.

In the present application, the first and second connection data lines can be provided to overlap in alternate columns, thereby achieving the effects of saving layout wiring space and reducing signal crosstalk.

Specifically, as shown in FIG. 4, the display panel further includes: a first metal layer 18, where the first portion 14 of each of the first connection data lines 131 is located in the first metal layer 18; an interlayer insulating layer 19 located below the first metal layer 18; and a second metal layer 20 located on a side of the interlayer insulating layer 19 away from the first metal layer 18, the first portion 14 of each of the second connection data lines 132 is located in the second metal layer 20. In this embodiment, the first portions of the first connection data lines are disposed in the first metal layer, and the first portions of the second connection data lines are disposed in the second metal layer. The isolation and insulation effect between the two metal layers is achieved through the interlayer insulating layer.

In addition to the interlayer insulating layer, other structural layers can also be provided between the first metal layer and the second metal layer. Those skilled in the art can select two metal layers with a larger interval as the first metal layer and the second metal layer, so as to minimize the coupling between the connection signal lines in the two layers.

According to some other exemplary embodiments of the present application, as shown in FIG. 5, the display panel further includes: a hole structure 21, which is at least half surrounded by the first trace area 11; and a plurality of scan lines 22, the plurality of scan lines 22 being arranged at intervals in the first direction and extend in a second direction. The scan lines 22 extend from the first display area 12 to the hole structure 21 along the second direction, bypass the hole structure 21, and extend from the first trace area 11 to the first display area 12 along the second direction. The first direction intersects the second direction. In this embodiment, the display panel is a display panel with a hole. The scan lines extend to both sides of the hole structure in the second direction by bypassing the hole structure, ensuring the continuity of the scan signals on both sides of the hole structure.

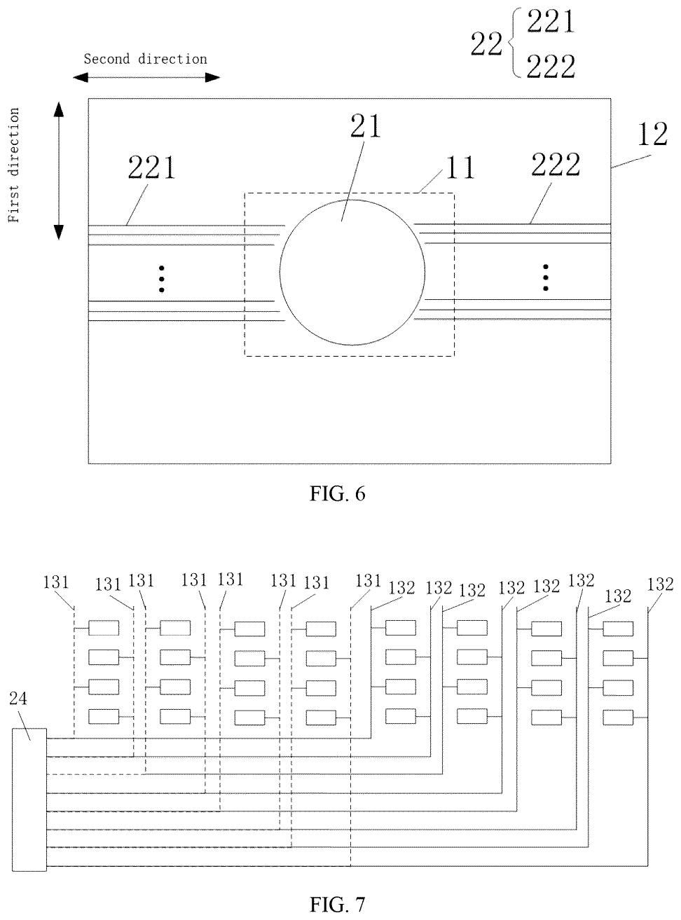

According to some further exemplary embodiments of the present application, as shown in FIG. 6, the display panel further includes: a hole structure 21, which is at least half surrounded by the first trace area 11; and a plurality of scan lines 22, the scan lines 22 each include a first scan sub-line 221 and a second scan sub-line 222. The first scan sub-line 221 extends from the first display area 12 to a first side of the hole structure 21 along the second direction, and the second scan sub-line 222 extends from a second side of the hole structure 21 to the first display area 12 along the second direction. The first side and the second side are the two opposite sides of the hole structure in the second direction. In this embodiment, the display panel is a display panel with a hole. One scan line includes two scan sub-lines. Scan sub-lines are respectively disposed on both sides of the hole structure and extend to the first display area. In this way, the number of winding lines in the first trace area can be reduced, thereby avoiding the problem of a large border of the first trace area. The load difference of the scan signal lines between the area with the hole structure and the area without the hole structure.

Specifically, within a same row period, input times of data signals of any two adjacent first connection data lines do not overlap, and input times of data signals of any two adjacent second connection data lines do not overlap. In this embodiment, two adjacent first connection data lines located in the same layer belong to data signal lines of alternate columns, and two adjacent second connection data lines located in the same layer also belong to data signal lines of alternate columns. There is no overlapping in time sequence, thus the problem of signal crosstalk between adjacent connection data lines can be further solved, and the better display effect of the display panel can be further ensured.

In the specific application process, the hole structure can be a blind-hole structure or a via-hole structure. Various electronic elements, for example a camera or watch hands, can be placed in the hole structure.

In a specific embodiment, the number of the hole structure is one, and an outer diameter of the hole structure is greater than or equal to 4 mm. In this embodiment, although there is only one hole structure in the display panel, the size of the hole structure is larger, resulting in a smaller space for wiring in the first trace area. The crosstalk between the connection signal lines in the first trace area is more serious. In this case, by adopting the design of disposing the first portions of the connection data lines corresponding to adjacent pixel column groups in different layers in the present application, the problem of crosstalk between the connection data lines with overlapping time sequences can be avoided. At the same time, a larger spacing between adjacent connection data lines can be ensured in the limited wiring space, thereby further avoiding the display split-screen phenomenon caused by signal crosstalk.

In another specific embodiment, there are a plurality of the hole structures, a diameter of each of the hole structures is less than 4 mm, and the plurality of the hole structures are disposed at intervals. In this embodiment, although the size of each of the hole structures in the display panel is not large, there are a plurality of the hole structures, resulting in a smaller space for wiring in the first trace area. The crosstalk between the connection signal lines in the first trace area is more serious. In this case, by adopting the design of disposing the first portions of the connection data lines corresponding to adjacent pixel column groups in different layers in the present application, the problem of crosstalk between the connection data lines with overlapping time sequences can be avoided. At the same time, a larger spacing between adjacent connection data lines can be ensured in the limited wiring space, thereby further avoiding the display split-screen phenomenon caused by signal crosstalk.

In addition, the first trace area further includes an edge region surrounding the hole structure, and a width of the edge region is less than or equal to 0.6 mm. Since the width of the edge region is smaller, the crosstalk between the connection signal lines in the edge region is more serious. In this case, by adopting the design of disposing the first portions of the connection data lines corresponding to adjacent pixel column groups in different layers in the present application, the problem of crosstalk between the connection data lines with overlapping time sequences can be avoided. At the same time, a larger spacing between adjacent connection data lines can be ensured in the limited wiring space, thereby further avoiding the display split-screen phenomenon caused by signal crosstalk.

The hole structure can be located in the middle of the display panel or at the edge of the display panel.

Optionally, the second portions of the plurality of connection data lines are located in a same layer. Since the wiring space in the first display area is larger, the connection data lines can be disposed with a larger interval in the first display area, and the crosstalk between the connection data lines is smaller. Therefore, the second portions of the plurality of connection data lines can be disposed in the same layer.

Of course, in addition to the above-mentioned setting way, in other exemplary embodiments, the second portions of the first connection data lines and the second portions of the second connection data lines can be located in different layers. Setting the second portions of the connection data lines corresponding to adjacent pixel column groups with overlapping time sequences in different layers can further solve the problem of signal crosstalk between the connection data lines corresponding to adjacent pixel column groups, and further ensure a better display effect of the display panel.

In the case where the second portions of the first connection data lines and the second portions of the second connection data lines are located in different layers, the setting of the relative position relationship between the second portions of the first connection data lines and the second portions of the second connection data lines in different layers can refer to the setting of the first portions, which will not be elaborated here in the present application.

In some embodiments, as shown in FIG. 1, the display panel 10 further includes: a second display area 26 located on at least one side of the first display area 12 along an arrangement direction of the connection data lines 13.

The display panel further includes: a plurality of third connection data lines located in the second display area, where the plurality of third connection data lines are arranged at intervals along the second direction, and each of the third connection data lines extends along the first direction; and a plurality of third pixel column groups located in the second display area, where each of the third pixel column groups includes at least two third pixel columns, and each of the third pixel column is electrically connected to two third connection data lines. The plurality of third connection data lines corresponding to two adjacent third pixel column groups can be located in the same layer.

FIG. 1 exemplarily shows an embodiment where the first display area 12 is located on the upper and lower sides of the first trace area 11, and the second display area 26 is located on the left and right sides of the first display area 12. In the actual application process, the positions of the first display area 12 and the second display area 26 are not limited to those shown in FIG. 1. For example, the first display area 12 can be only located below the first trace area 11; and for another example, the second display area 26 can be only located on the left or right side of the first display area 12.

In some embodiments, as shown in FIG. 1, the display panel further includes: a non-display area 23 located at least on one side of the first display area 12; a multiplexer 24 located in the non-display area 23, one end of each of the second portions 15 is electrically connected to the multiplexer 24. By providing the multiplexer, the multiplexing of the communication channel can be realized, the capacity of the communication channel can be fully utilized, the system cost can be reduced, and at the same time, the efficiency and reliability of signal transmission can be improved.

Exemplarily, the multiplexer is a 1:n multiplexer, where n≥4.

In addition, the display panel further includes: a shift register located in the non-display area and electrically connected to the plurality of scan lines. Through the shift register, the function of driving the display panel for line-by-line scanning is realized.

FIG. 7 exemplarily shows a structural schematic view of two adjacent pixel column groups of a display panel using a 1:4 multiplexer. As shown in FIG. 7, the display panel includes adjacent first pixel column group and second pixel column group. The first pixel column group and the second pixel column group each include four pixel columns. The first connection data lines 131 corresponding to the first pixel column group and the second connection data lines 132 corresponding to the second pixel column group are electrically connected to the same 1:4 multiplexer 24.

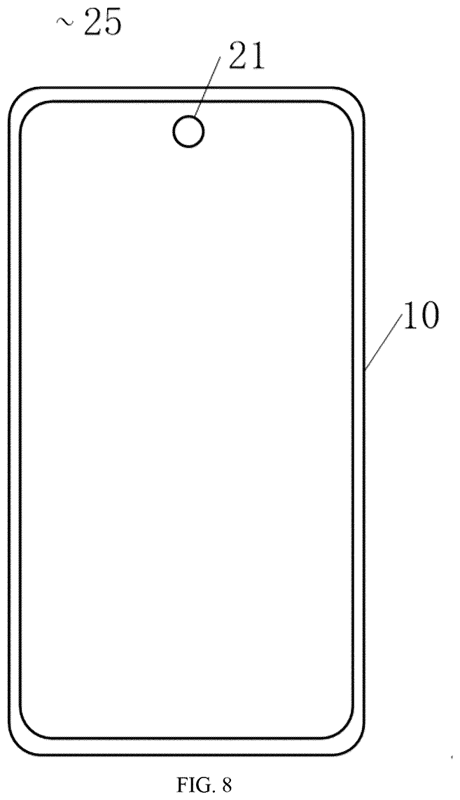

An embodiment of the present application further provides a display device 25. As shown in FIG. 8, the display device 25 includes any of the above-mentioned display panels 10.

In the display device, the first display area of the display panel at least half encloses the first trace area, the first display area is provided with the plurality of pixel column groups, each of the pixel column groups includes at least two pixel columns, each of the pixel columns is electrically connected to two connection data lines correspondingly, signal transmission is carried out through the DDL method, the first portion of each of the connection data lines is located in the first trace area, the second portion of each of the connection data lines is located in the first display area, and the first portions of the connection data lines corresponding to adjacent pixel column groups are located in different layers. Since the signals transmitted by the connection data lines corresponding to adjacent pixel column groups have overlapping time sequences, and the wiring space in the first trace area is smaller, the connection data lines in the first trace area are prone to signal crosstalk problem. In the display panel of the present application, the first portions of the connection data lines corresponding to adjacent pixel column groups are disposed in different layers, avoiding the problem of signal crosstalk between the connection data lines corresponding to adjacent pixel column groups, realizing high-quality and stable signal transmission, and ensuring a better display effect of the display device. Moreover, compared with disposing the first portions corresponding to adjacent pixel column groups in the same layer, in the present application, the wiring interval of the first portions on each layer does not need to consider the crosstalk problem, so that the spacing between adjacent first portions can be smaller, thereby ensuring that the wiring area occupied by the first portions in the first trace area is smaller, which is conducive to the miniaturization design of the display device.

As shown in FIG. 8, the display panel is a display panel with a hole structure 21.

It should also be noted that the terms “include”, “comprise” or any other variants thereof are intended to cover and be non-exclusive inclusion, so that a process, method, commodity, or device that includes a series of elements not only includes those elements, but also includes other elements not explicitly listed, or elements inherent to this process, method, commodity, or device. Without further limitations, an element defined by the statement “including one . . . ” does not exclude the existence of other identical elements in the process, method, commodity, or device that includes the element.

From the above description, it can be seen that the embodiments of the present application achieve the following technical effects:

1) In the display panel of the present application, the first display area at least half encloses the first trace area, the first display area is provided with the plurality of pixel column groups, each of the pixel column groups includes at least two pixel columns, each of the pixel columns is electrically connected to two connection data lines correspondingly, signal transmission is carried out through the DDL method, the first portion of each of the connection data lines is located in the first trace area, the second portion of each of the connection data lines is located in the first display area, and the first portions of the connection data lines corresponding to adjacent pixel column groups are located in different layers. Due to the smaller wiring space in the first trace area, the connection data lines in the first trace area are prone to signal crosstalk problem. In the present application, the first portions of the connection data lines corresponding to adjacent pixel column groups are disposed in different layers, so that adjacent connection data lines in the same layer correspond to the pixel column groups in alternate columns. When the connection data lines of the pixel column groups in alternate columns are charged, there is no time sequence overlap, avoiding the problem of signal crosstalk between the connection data lines corresponding to adjacent pixel column groups, realizing high-quality and stable signal transmission, and ensuring a better display effect of the display panel. Moreover, compared with disposing the first portions corresponding to adjacent pixel column groups in the same layer, in the present application, the wiring interval of the first portions on each layer does not need to consider the crosstalk problem, so that the spacing between adjacent first portions can be smaller, thereby ensuring that the wiring area occupied by the first portions in the first trace area is smaller.

2) In the display device of the present application, the first display area of the display panel at least half encloses the first trace area, the first display area is provided with the plurality of pixel column groups, each of the pixel column groups includes at least two pixel columns, each of the pixel columns is electrically connected to two connection data lines correspondingly, signal transmission is carried out through the DDL method, the first portion of each of the connection data lines is located in the first trace area, the second portion of each of the connection data lines is located in the first display area, and the first portions of the connection data lines corresponding to adjacent pixel column groups are located in different layers. Since the signals transmitted by the connection data lines corresponding to adjacent pixel column groups have overlapping time sequences, and the wiring space in the first trace area is smaller, the connection data lines in the first trace area are prone to signal crosstalk problem. In the display panel of the present application, the first portions of the connection data lines corresponding to adjacent pixel column groups are disposed in different layers, avoiding the problem of signal crosstalk between the connection data lines corresponding to adjacent pixel column groups, realizing high-quality and stable signal transmission, and ensuring a better display effect of the display device. Moreover, compared with disposing the first portions corresponding to adjacent pixel column groups in the same layer, in the present application, the wiring interval of the first portions on each layer does not need to consider the crosstalk problem, so that the spacing between adjacent first portions can be smaller, thereby ensuring that the wiring area occupied by the first portions in the first trace area is smaller, which is conducive to the miniaturization design of the display device.

The above are only the preferred embodiments of the present application and are not intended to limit the present application. For those skilled in the art, the present application can have various changes and modifications. Any modifications, equivalent replacements, improvements, etc. made within the spirit and principles of the present application should be included in the protection scope of the present application.

What is claimed is:

1. A display panel, comprising:
a first trace area;
a first display area at least half-surrounding the first trace area;
connection data lines, wherein one of the connection data lines comprises a first portion and a second portion electrically connected to each other, the first portion located in the first trace area, and the second portion located in the first display area; and
pixel column groups located in the first display area, wherein one of the pixel column groups comprises at least two pixel columns, and one of the pixel columns is electrically connected to two connection data lines;
wherein the pixel column groups comprise adjacent first pixel column group and second pixel column group, and the connection data lines comprise first connection data lines corresponding to the first pixel column group and second connection data lines corresponding to the second pixel column group,
wherein the first portions of the first connection data lines and the first portions of the second connection data lines are located in different layers.

2. The display panel according to claim 1, wherein in a thickness direction of the display panel, the first portions of the first connection data lines and the first portions of the second connection data lines overlap each other.

3. The display panel according to claim 2, wherein one of the pixel columns located at a preset position in the first pixel column group is a first target pixel column, one of the pixel columns located at a preset position in the second pixel column group is a second target pixel column,
wherein the first portion of one of the two first connection data lines electrically connected to the first target pixel column is a first target portion, the first portion of one of the two second connection data lines electrically connected to the second target pixel column is a second target portion, and
in the thickness direction of the display panel, at least one of two first target portions and at least one of two second target portions overlap each other.

4. The display panel according to claim 3, wherein in the thickness direction of the display panel, the first target portion and the second target portion overlap each other in a one-to-one correspondence.

5. The display panel according to claim 1, wherein a plurality of first pixel column groups and a plurality of second pixel column groups are provided,
the plurality of first pixel column groups are arranged in odd columns, the plurality of second pixel column groups are arranged in even columns, the first portions of all the first connection data lines are located in a same layer, and the first portions of all the second connection data lines are located in another same layer.

6. The display panel according to claim 5, further comprising:
a first metal layer, wherein the first portion of one of the first connection data lines is located in the first metal layer;
an interlayer insulating layer located below the first metal layer; and
a second metal layer located on a side of the interlayer insulating layer facing away from the first metal layer, wherein the first portion of one of the second connection data lines is located in the second metal layer.

7. The display panel according to claim 6, further comprising:
a hole structure, at least half surrounded by the first trace area; and
scan lines, arranged at intervals in a first direction and extending in a second direction, wherein the scan lines extend from the first display area to the hole structure along the second direction, bypassing the hole structure and extending from the first trace area to the first display area along the second direction, and the first direction intersect the second direction.

8. The display panel according to claim 6, further comprising:
a hole structure, at least half surrounded by the first trace area;
scan lines, wherein one of the scan lines comprises a first scan sub-line and a second scan sub-line, the first scan sub-line extends from the first display area to a first side of the hole structure along the second direction, the second scan sub-line extends from a second side of the hole structure to the first display area along the second direction, and
the first side and the second side are two opposite sides of the hole structure in the second direction.

9. The display panel according to claim 5, wherein within a same row period, input times of data signals of any two adjacent first connection data lines do not overlap, and input times of data signals of any two adjacent second connection data lines do not overlap.

10. The display panel according to claim 7 or 8, wherein one hole structure is provided, and an outer diameter of the hole structure is greater than or equal to 4 mm.

11. The display panel according to claim 7 or 8, wherein a plurality of hole structures are provided, a diameter of one of the hole structures is less than 4 mm, and the plurality of the hole structures are disposed at intervals.

12. The display panel according to claim 7 or 8, wherein the first trace area further comprises an edge region surrounding the hole structure, and a width of the edge region is less than or equal to 0.6 mm.

13. The display panel according to claim 1, wherein the second portions of the connection data lines are located in a same layer.

14. The display panel according to claim 13, further comprising:
a non-display area located at least on one side of the first display area;
a multiplexer located in the non-display area, wherein one end of one of the second portions is electrically connected to the multiplexer.

15. The display panel according to claim 14, wherein the multiplexer is a 1:n multiplexer, where n≥4.

16. A display device comprising a display panel, wherein the display panel comprises:
a first trace area;
a first display area at least half-surrounding the first trace area;
connection data lines, wherein one of the connection data lines comprises a first portion and a second portion electrically connected to each other, the first portion located in the first trace area, and the second portion located in the first display area; and
pixel column groups located in the first display area, wherein one of the pixel column groups comprises at least two pixel columns, and one of the pixel columns is electrically connected to two connection data lines;
wherein the pixel column groups comprise adjacent first pixel column group and second pixel column group, and the connection data lines comprise first connection data lines corresponding to the first pixel column group and second connection data lines corresponding to the second pixel column group,
wherein the first portions of the first connection data lines and the first portions of the second connection data lines are located in different layers.
